(19) United States
(12) Patent Application Publication
(10) Pub. No.: US 2026/0212292 A1
(43) Pub. Date: Jul. 23, 2026

(54) INTEGRATED SALES LEADS MATCHING PLATFORM

(71) Applicant: Lee Brown, Jensen Beach, FL (US)

(72) Inventor: Lee Brown, Jensen Beach, FL (US)

(21) Appl. No.: 19/567,511

(22) Filed: Mar. 16, 2026

Related U.S. Application Data
(63) Continuation-in-part of application No. 18/613,182, filed on Mar. 22, 2024, now abandoned.

(51) Int. Cl. G06Q 10/0631; G06Q 30/0201

(52) U.S. Cl. CPC G06Q 10/06312; G06Q 10/06311; G06Q 30/020121

(57) ABSTRACT

A sales leads and task matching system comprises at least one processor, configured to receive, potential lead data, one or more satellite images and sales resources data; determine one or more product parameters of a property based at least on the received one or more satellite images; generate, feature values; apply, via a machine-learning model, weighting factors to the generated feature values; generate, a sales leads matching output for a pairing of one of the potential lead data and one of the sales resources data; derive, a match percentage; generate, new sales schedules, and issue the new sales schedules to available sales resources from the one or more sales resources; record, execution data generated from execution of the new sales schedules; determine, key indicators from the execution data; update the machine-learning model by adjusting weighting factors; and generate, a next generation of new sales schedules using the updated machine-learning model.

### CROSS-REFERENCE TO RELATED APPLICATIONS

This application is a continuation-in-part of U.S. Non-Provisional patent application Ser. No. 18/613,182, filed on Mar. 22, 2024, the entire disclosures of which are hereby incorporated by reference in their entirety.

### FIELD OF INVENTION

Example embodiments of the present disclosure relate to sale leads management system, and more particularly relate to a sales leads and task matching system a method thereof.

### BACKGROUND

Many methods, devices, and systems have been unsuccessfully attempted to integrate a comprehensive platform for managing sales leads and matching those leads with sales resources in an effective and efficient manner while taking into consideration available input resources and functional application requirements. Many of these prior attempts have been costly, cumbersome to use, and difficult to scale, and quite often failed to account for rapidly changing variables associated with customers, sales resources, geographic constraints, and operational conditions. In many existing sales environments, sales professionals and managers rely on manually selected or semi-automated processes to choose sales leads and match those leads with sales resources. Such manual or rule-based approaches are time-consuming, vulnerable to subjective decision-making, and prone to inconsistency across different users, teams, or locations. As a result, these approaches often lead to inefficient allocation of sales resources, suboptimal scheduling, and increased operational costs.

Further, conventional systems frequently operate on static data or fixed rules and do not adequately incorporate feedback from prior sales activities or execution outcomes. As a result, such systems are unable to adapt to changing sales conditions, evolving performance characteristics of sales resources, or varying attributes of potential customers. In addition, many existing platforms require extensive manual data entry or configuration, increasing transaction costs and reducing overall efficiency. Some existing systems also fail to integrate disparate data sources, such as customer information, sales resource attributes, geographic considerations, and property-related data, into a unified decision-making framework. This lack of integration further limits the ability of such systems to generate accurate, data-driven matching decisions or to continuously improve performance over time.

Accordingly, there exists an established need for improved sales leads matching systems that overcome one or more of the foregoing deficiencies. In particular, there is a need for computer-based systems that can efficiently and effectively match sales leads or tasks with appropriate sales resources while reducing reliance on manual processes, accommodating dynamically changing variables, and supporting scalable operation without excessive cost or administrative burden.

### BRIEF SUMMARY

The following presents a summary of some example embodiments to provide a basic understanding of some aspects of the present disclosure. This summary is not an extensive overview and is intended to neither identify key or critical elements nor delineate the scope of such elements. It will also be appreciated that the scope of the disclosure encompasses many potential embodiments in addition to those here summarized, some of which will be further described in the detailed description that is presented later.

In an example embodiment, a sales leads and task matching system is disclosed. The sales leads and task matching system comprises a data storage module configured to store potential lead data, one or more satellite images associated with a property of one or more customers and sales resources data associated with one or more sales resources. Further, the sales leads and task matching system comprises a memory configured to store one or more instructions, and at least one processor communicatively coupled to the data storage module and the memory. Further, the sales leads and task matching system comprises a feature generation module communicatively coupled to the at least one processor; a scheduling module communicatively coupled to the at least one processor; an execution data module communicatively coupled to the at least one processor; and a key indicator module communicatively coupled to the at least one processor. The at least one processor, when executing the one or more instructions, is configured to receive, via the data storage module, the potential lead data, the one or more satellite images and the sales resources data, wherein the sales resources data comprises at least age information and education information of the one or more sales resources; determine one or more product parameters of the property based at least on the received one or more satellite images, wherein the one or more product parameters comprise at least one of a square footage area of the property or a material quantity associated with the property; generate, via the feature generation module, feature values derived from the potential lead data, the sales resources data, the one or more product parameters, and a previously saved sales schedules and associated execution data; apply, via a machine-learning model communicatively coupled to the at least one processor, weighting factors to the generated feature values; generate, via the machine-learning model and based at least on the weighted feature values, a sales leads matching output for a pairing of one of the potential lead data and one of the sales resources data; derive, based at least on the generated sales leads matching output, a match percentage representing a predicted compatibility for the pairing between the one of the potential lead data and the one of the sales resources data; generate, via the scheduling module, new sales schedules based at least on the generated sales leads matching output and the derived match percentage, and issue the new sales schedules to available sales resources from the one or more sales resources; record, via the execution data module, execution data generated from execution of the new sales schedules, including sales outcomes associated with the issued sales schedules; determine, via the key indicator module, key indicators from the execution data, wherein the key indicators include at least the match percentage, and a sales percentage representing an actual sales outcome; update the machine-learning model by adjusting weighting factors stored in the memory based at least on a comparison between the match percentage and the sales percentage; and generate, via the scheduling module, a next generation of new sales schedules using the updated machine-learning model. In some embodiments, updating the machine-learning model reduces computational processing of incompatible pairings and improves efficiency and accuracy of subsequent schedule generation cycles.

In some embodiments, the feature values comprise numerical representations generated from at least one of attributes of the potential lead data, attributes of the sales resources data, and the one or more product parameters.

In some embodiments, the previously saved sales schedules comprise previously generated sales schedules stored in the data storage module and associated with historical assignments of the potential lead data to the one or more sales resources. In some embodiments, the execution data comprise data recorded by the system during execution of the previously generated sales schedules, including at least one of acceptance data, completion data, timing data, or sales outcome data.

In some embodiments, the machine-learning model comprises a plurality of executable instructions stored in the memory and configured to generate the match percentage using weighted feature values derived from the potential lead data, the sales resources data, and the execution data. In some embodiments, the machine-learning model comprises a self-learning continuing improving set of algorithms configured to update the weighted feature values based on the execution data stored in the memory. In some embodiments, the self-learning continuing improving set of algorithms updates the weighted feature values further based on industry specific data and user input.

In some embodiments, the at least one processor, when executing the one or more instructions, is further configured to apply a hierarchy of criteria including mandatory criteria, disqualifying criteria, and weighted compatibility criteria to exclude incompatible pairings of potential lead data and sales resources data prior to generating the sales leads matching output.

In some embodiments, the at least one processor when executing the one or more instructions, is further configured to determine location-based preferences, receive sales resources location data, and calculate drive times of the sales resources for adjusting the new sales schedules.

In some embodiments, the at least one processor when executing the one or more instructions, is further configured to determine unavailable sales resources based on availability data stored in the memory, and to prevent issuance of the new sales schedules to the determined unavailable sales resources.

In some embodiments, processing the satellite images comprises executing image-based computational routines by the at least one processor to determine the one or more product parameters without manual user input.

In some embodiments, updating the machine-learning model based on the execution data reduces a number of pairings of the potential lead data and the sales resources data processed by the at least one processor when generating the next generation of new sales schedules.

In some embodiments, updating the machine-learning model comprises training the machine-learning model using execution data stored in the memory within a rolling temporal window.

In some embodiments, the at least one processor, when executing the one or more instructions, is further configured to record acceptance or rejection of the issued new sales schedules by the one or more sales resources and to reassign a rejected sales schedule to another sales resource selected from the one or more sales resources.

In some embodiments, the at least one processor, when executing the one or more instructions, dynamically adjusts the new sales schedules based on detected execution events including at least one of cancellation, non-acceptance, or early completion.

In some embodiments, the at least one processor generates differentiated subsets of the key indicators for presentation to different user roles including at least a business owner role, a manager role, and a sales resource role.

A computer-implemented method for sales lead matching and task scheduling, executed by at least one processor communicatively coupled to a data storage module and a memory, the method comprising receiving potential lead data, one or more satellite images, and sales resources data; determining one or more product parameters of the property based at least on the received one or more satellite images, including executing automated image-based boundary detection and area estimation routines without manual user input; generating feature values derived from the potential lead data, the sales resources data, the one or more product parameters, and a previously saved sales schedules and associated execution data; applying, using a machine-learning model, weighting factors to the generated feature values; generating, using the machine-learning model, a sales lead matching output for a pairing of one of the potential lead data and one of the sales resources data; deriving a match percentage representing predicted compatibility for the pairing between the one of the potential lead data and the one of the sales resources data, based at least on the generated sales leads matching output; generating, using a scheduling module, new sales schedules based at least on the generated sales leads matching output and the derived match percentage, and issue the new sales schedules to available sales resources from the one or more sales resources; recording, using an execution data module, execution data generated from execution of the new sales schedules, including sales outcomes associated with the issued sales schedules; determining, using a key indicator module, key indicators from the execution data, wherein the key indicators include at least the match percentage, and a sales percentage representing an actual sales outcome; and updating the machine-learning model by adjusting weighting factors stored in the memory based at least on a comparison between the match percentage and the sales percentage to generate, a next generation of new sales schedules, wherein the updating reduces computational processing in subsequent matching operations.

In another example embodiment, a non-transitory computer-readable medium storing instructions that, when executed by at least one processor, cause the at least one processor to receiving, via at least one processor communicatively coupled to a data storage module and a memory, a potential lead data, one or more satellite images and sales resources data from the data storage module, wherein the sales resources data comprises at least age information and education information of the one or more sales resources; determining, via the at least one processor, one or more product parameters of the property based at least on the received one or more satellite images, wherein the one or more product parameters comprise at least one of a square footage area of the property or a material quantity associated with the property; generating, via the at least one processor, feature values derived from the potential lead data, the sales resources data, the one or more product parameters, and a previously saved sales schedules and associated execution data; applying, via the at least one processor and using a machine-learning model communicatively coupled to the at least one processor, weighting factors to the generated feature values; generating, via the at least one processor and using the machine-learning model, a sales leads matching output for a pairing of one of the potential lead data and one of the sales resources data, based at least on the weighted feature values; deriving, via the at least one processor, a match percentage representing a predicted compatibility for the pairing between the one of the potential lead data and the one of the sales resources data, based at least on the generated sales leads matching output; generating, via the at least one processor using a scheduling module, new sales schedules based at least on the generated sales leads matching output and the derived match percentage, and issue the new sales schedules to available sales resources from the one or more sales resources; recording, via the at least one processor using an execution data module, execution data generated from execution of the new sales schedules, including sales outcomes associated with the issued sales schedules; determining, via the at least one processor using a key indicator module, key indicators from the execution data, wherein the key indicators include at least the match percentage, and a sales percentage representing an actual sales outcome; updating, via the at least one processor, the machine-learning model by adjusting weighting factors stored in the memory based at least on a comparison between the match percentage and the sales percentage; and generating, via the at least one processor using the scheduling module, a next generation of new sales schedules using the updated machine-learning model.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a block diagram for sales leads and task matching system, in accordance with an example embodiment of the present disclosure;

FIG. 2 illustrates a block diagram of a server, in accordance with an example embodiment of the present disclosure;

FIG. 3 illustrates an example operational environment in which the sales leads and task matching system is described herein may be implemented and used in a real-world scenario, in accordance with an example embodiment of the present disclosure; and

FIG. 4 illustrates a flowchart for showing a method for sales leads and task matching, in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of a sales leads and task matching system. The embodiments of the sales leads and task matching system comprises a data storage module configured to store potential lead data, one or more satellite images associated with a property of one or more customers and sales resources data associated with one or more sales resources. Further, the sales leads and task matching system comprises a memory configured to store one or more instructions, and at least one processor communicatively coupled to the data storage module and the memory. The at least one processor, when executing the one or more instructions, is configured to receive, via the data storage module, the potential lead data, the one or more satellite images and the sales resources data, wherein the sales resources data comprises at least age information and education information of the one or more sales resources; determine one or more product parameters of the property based at least on the received one or more satellite images, wherein the one or more product parameters comprise at least one of a square footage area of the property or a material quantity associated with the property; generate, via feature generation module, feature values derived from the potential lead data, the sales resources data, the one or more product parameters, and a previously saved sales schedules and associated execution data; apply, via a machine-learning model communicatively coupled to the at least one processor, weighting factors to the generated feature values; generate, via the machine-learning model and based at least on the weighted feature values, a sales leads matching output for a pairing of one of the potential lead data and one of the sales resources data; derive, based at least on the generated sales leads matching output, a match percentage representing a predicted compatibility for the pairing between the one of the potential lead data and the one of the sales resources data; generate, via scheduling module, new sales schedules based at least on the generated sales leads matching output and the derived match percentage, and issue the new sales schedules to available sales resources from the one or more sales resources; record, via execution data module, execution data generated from execution of the new sales schedules, including sales outcomes associated with the issued sales schedules; determine, via key indicator module, key indicators from the execution data, wherein the key indicators include at least the match percentage, and a sales percentage representing an actual sales outcome; update the machine-learning model by adjusting weighting factors stored in the memory based at least on a comparison between the match percentage and the sales percentage; and generate, via the scheduling module, a next generation of new sales schedules using the updated machine-learning model.

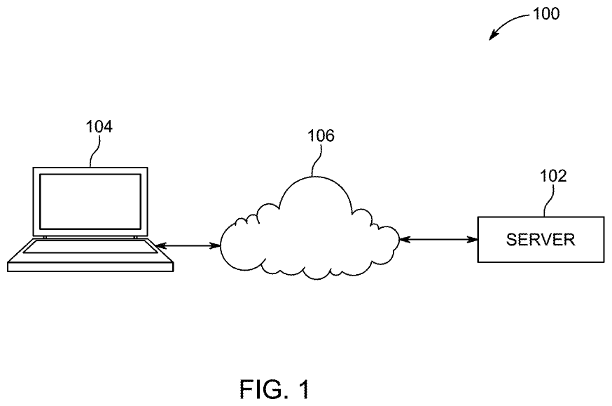

FIG. 1 illustrates a block diagram for sales leads and task matching system 100, in accordance with an example embodiment of the present disclosure.

In some embodiments, the sales leads and task matching system 100 comprises a server 102, a user interface 104 and a network 106. In some embodiments, the server 102 operates as a centralized computing system that supports execution of the sales leads and task matching system 100 described herein. The server 102 is configured to communicate with one or more remote devices over a communications network and to manage receipt, storage, and transmission of data associated with sales lead matching and scheduling operations. The server 102 is configured to receive potential lead data, sales resources data, and one or more satellite images associated with a property of one or more customers. The server 102 is further configured to generate, update, and issue sales schedules to available sales resources and to receive execution data generated from execution of the issued sales schedules, including sales outcomes and related information.

In some embodiments, the server 102 functions as a primary execution environment for implementing data processing, matching, scheduling, and learning operations of the sales leads and task matching system. The server 102 may store and manage data used by the system and may coordinate interactions between data sources, scheduling outputs, and user-facing devices through the communications network. The internal components and functional operations of the server 102, including execution of instructions and interaction with stored data, are described in further detail with reference to FIG. 1. As further illustrated in FIG. 1, the user interface 104 is communicatively coupled to the server 102 through the network 106. The user interface 104 provides an interaction point through which users may exchange information with the sales leads and task matching system executed by the server 102.

In various embodiments, the user interface 104 may be implemented on one or more remote computing devices, including but not limited to a laptop computer, a desktop computer, a mobile device, or another network-enabled device. The specific form factor or hardware configuration of the user interface 104 is not limiting. The user interface 104 is configured to transmit data to the server 102 and to receive data from the server 102 via the network 106. In some embodiments, the user interface 104 enables entry, review, or transmission of potential lead data, sales resources data, and other information associated with sales leads and task matching operations. The user interface 104 may further receive sales schedules generated by the server 102 and present such sales schedules to users associated with the one or more sales resources. In addition, the user interface 104 may facilitate communication of execution data to the server 102, including information generated from execution of issued sales schedules, such as acceptance, completion, or sales outcome information. The user interface 104 operates as a communication interface through which data is exchanged with the server 102.

Further, as shown in FIG. 1, the network 106 provides a communication medium through which the server 102 communicates with the user interface 104 and other remote devices associated with the sales leads and task matching system. The network 106 enables transmission of data between the server 102 and the user interface 104 for purposes of receiving, processing, and distributing information related to sales lead matching and scheduling operations. In various embodiments, the network 106 may comprise one or more communication networks, including but not limited to a wired network, a wireless network, a cellular network, a local area network (LAN), a wide area network (WAN), the Internet, or combinations thereof. The specific configuration or communication protocol of the network 106 is not limiting. The network 106 is configured to support bidirectional data communication between the server 102 and the user interface 104. Through the network 106, the server 102 may receive potential lead data, sales resources data, one or more satellite images, and execution data, and may transmit sales schedules, notifications, and other data generated by the sales leads and task matching system.

In some embodiments, the server 102 is first configured to receive, the potential lead data, the one or more satellite images and the sales resources data. In some embodiments, the sales resources data comprises at least age information and education information of the one or more sales resources. The potential lead data is data associated with one or more customers and is used by the server 102 for sales leads and task matching operations. The one or more satellite images are images associated with a property of the one or more customers and are used by the server 102 for determining product parameters of the property. The sales resources data is data associated with the one or more sales resources available to receive sales schedules generated by the server 102. In some embodiments, the sales resources data comprises at least age information and education information of the one or more sales resources. The server 102 receives the potential lead data, the one or more satellite images, and the sales resources data for subsequent processing and use in generating feature values, sales leads matching output, and sales schedules, as described in further detail below.

In some embodiments, the server 102 is further configured to determine one or more product parameters of the property based at least on the received one or more satellite images. In some embodiments, the one or more product parameters comprise at least one of a square footage area of the property or a material quantity associated with the property. In performing this determination, the server 102 analyses the received one or more satellite images associated with the property to identify dimensional characteristics of the property. Based at least on the analysis of the one or more satellite images, the server 102 derives measurement information corresponding to the property and uses the measurement information to determine the one or more product parameters. The square footage area of the property represents a calculated area associated with the property as determined from the one or more satellite images, and the material quantity associated with the property represents an amount of material correlated to the square footage area of the property.

In some embodiments, the server 102 determines the one or more product parameters without requiring manual user input after receipt of the one or more satellite images. The determined one or more product parameters are stored by the server 102 and are subsequently used as inputs for generating feature values and for further sales leads and task matching operations, as described in subsequent steps. Further, the server 102 is configured to generate, feature values derived from the potential lead data, the sales resources data, the one or more product parameters, and a previously saved sales schedules and associated execution data. In generating the feature values, the server 102 processes the potential lead data, the sales resources data, the one or more product parameters, and the previously saved sales schedules and associated execution data to produce numerical representations usable for sales leads and task matching operations. The feature values represent quantified attributes corresponding to the potential lead data, attributes corresponding to the sales resources data, and attributes corresponding to the one or more product parameters.

The previously saved sales schedules comprise previously generated sales schedules stored by the server 102 and associated with historical assignments of the potential lead data to the one or more sales resources. The execution data comprises data generated from execution of the previously generated sales schedules, including sales outcomes and related execution information. The server 102 uses the previously saved sales schedules and the execution data to incorporate historical assignment and performance information into the generated feature values. In some embodiments, the server 102 generates the feature values such that the feature values collectively represent a unified data set derived from current input data and historical data. The generated feature values are stored by the server 102 and are subsequently used for application of weighting factors and generation of sales leads matching output, as described in subsequent steps.

Further, the server 102 is configured to apply weighting factors to the generated feature values. In applying the weighting factors, the server 102 assigns relative importance to the generated feature values based on their relevance to sales leads and task matching operations. The weighting factors are values used by the server 102 to emphasize or de-emphasize individual feature values when evaluating potential lead data in relation to sales resources data. In some embodiments, the weighting factors applied by the server 102 reflect historical performance information derived from the execution data and the previously saved sales schedules. By applying the weighting factors to the generated feature values, the server 102 produces weighted feature values that account for both current input data and historical execution outcomes. The weighted feature values generated by the server 102 are used as inputs for generation of sales leads matching output, as described in further detail below.

Further, the server 102 is configured to generate, based at least on the weighted feature values, a sales leads matching output for a pairing of one of the potential lead data and one of the sales resources data. In generating the sales leads matching output, the server 102 evaluates the weighted feature values to assess a relationship between the one of the potential lead data and the one of the sales resources data. The sales leads matching output represents an output produced by the server 102 that corresponds to a specific pairing of the one of the potential lead data with the one of the sales resources data. In some embodiments, the server 102 generates the sales leads matching output for a plurality of pairings of the potential lead data and the sales resources data and identifies one or more pairings for use in subsequent scheduling operations. The sales leads matching output produced by the server 102 serves as a basis for determining compatibility between the potential lead data and the sales resources data and is subsequently used to derive a match percentage and to generate new sales schedules, as described in further detail below.

Further, the server 102 is configured to derive, based at least on the generated sales leads matching output, a match percentage representing a predicted compatibility for the pairing between the one of the potential lead data and the one of the sales resources data. In deriving the match percentage, the server 102 processes the generated sales leads matching output to produce a quantitative value representing the predicted compatibility for the pairing between the one of the potential lead data and the one of the sales resources data. The match percentage represents a relative measure of suitability of the sales resource for the potential lead based on the weighted feature values evaluated by the server 102. In some embodiments, the server 102 derives the match percentage such that higher match percentage values correspond to greater predicted compatibility between the potential lead data and the sales resources data, and lower match percentage values correspond to lower predicted compatibility. The derived match percentage is stored by the server 102 and is subsequently used for generating new sales schedules and for determining key indicators based on execution data, as described in subsequent steps.

Further, the server 102 is configured to generate, new sales schedules based at least on the generated sales leads matching output and the derived match percentage, and issue the new sales schedules to available sales resources from the one or more sales resources. In generating the new sales schedules, the server 102 selects one or more pairings of the potential lead data and the sales resources data based at least on the generated sales leads matching output and the derived match percentage. The new sales schedules identify assignments of the potential lead data to available sales resources from the one or more sales resources for execution. In some embodiments, the server 102 issues the new sales schedules by transmitting schedule information to the available sales resources through the network 106. The issued new sales schedules define timing and assignment information associated with the potential lead data and are used by the available sales resources for execution. The server 102 stores the issued new sales schedules for subsequent reference and use in recording execution data, as described in further detail below.

Further, the server 102 is configured to record, execution data generated from execution of the new sales schedules, including sales outcomes associated with the issued sales schedules. In recording the execution data, the server 102 receives information generated during execution of the issued new sales schedules by the available sales resources. The execution data reflects performance results associated with the issued sales schedules and includes sales outcomes corresponding to the potential lead data assigned in the new sales schedules. In some embodiments, the server 102 stores the execution data in association with the corresponding new sales schedules and the sales resources data. The recorded execution data is subsequently used by the server 102 for determining key indicators and for updating the machine-learning model based on a comparison between predicted compatibility and actual sales outcomes, as described in further detail below.

Further, the server 102 is configured to determine, key indicators from the execution data, wherein the key indicators include at least the match percentage, and a sales percentage representing an actual sales outcome. In determining the key indicators, the server 102 analyzes the execution data recorded from execution of the new sales schedules to evaluate performance results associated with the issued sales schedules. The match percentage included in the key indicators corresponds to the predicted compatibility previously derived for the pairing between the one of the potential lead data and the one of the sales resources data. The sales percentage included in the key indicators represents an actual sales outcome determined from the execution data. In some embodiments, the server 102 determines the key indicators such that the match percentage and the sales percentage are associated with the same pairing of the potential lead data and the sales resources data. The determined key indicators are stored by the server 102 and are subsequently used for updating the machine-learning model by comparing predicted compatibility to actual sales outcomes, as described in further detail below.

Further, the server 102 is configured to update its sales leads and task matching operations based at least on a comparison between the match percentage representing predicted compatibility and the sales percentage representing the actual sales outcome. In performing the update, the server 102 modifies internal weighting applied during sales leads and task matching operations such that subsequent evaluations reflect performance results derived from execution of prior sales schedules. In some embodiments, the server 102 updates its sales leads and task matching operations using the execution data to improve alignment between predicted compatibility and actual sales outcomes. The updated weighting applied by the server 102 is used in subsequent sales leads and task matching operations to improve efficiency and effectiveness of schedule generation.

Further, the server 102 is configured to generate a next generation of new sales schedules based at least on the updated sales leads and task matching operations. The next generation of new sales schedules reflects adjustments derived from prior execution data and is generated using updated weighting applied by the server 102. In some embodiments, the server 102 issues the next generation of new sales schedules to available sales resources and uses execution data generated from execution of the next generation of new sales schedules for further updating of sales leads and task matching operations, thereby enabling iterative improvement over successive schedule generations.

Further, the server 102 is configured to apply a hierarchy of criteria including mandatory criteria, disqualifying criteria, and weighted compatibility criteria to exclude incompatible pairings of potential lead data and sales resources data prior to generating the sales leads matching output. In applying the hierarchy of criteria, the server 102 evaluates the potential lead data and the sales resources data to identify pairings that do not satisfy one or more predefined conditions for assignment. The mandatory criteria represent conditions that must be satisfied for a pairing to be considered eligible, and pairings that fail to satisfy the mandatory criteria are excluded by the server 102 from further evaluation. The disqualifying criteria represent conditions that, when present, cause the server 102 to exclude a pairing of the potential lead data and the sales resources data from consideration, regardless of other attributes associated with the pairing. The weighted compatibility criteria are applied by the server 102 to remaining eligible pairings to further assess relative suitability prior to generation of the sales leads matching output.

Further, the server 102 is configured to record acceptance or rejection of the issued new sales schedules by the one or more sales resources and to reassign a rejected sales schedule to another sales resource selected from the one or more sales resources. In performing this operation, the server 102 receives information indicating acceptance or rejection of the issued new sales schedules from the one or more sales resources. The acceptance or rejection information is recorded by the server 102 in association with the corresponding new sales schedules and the sales resources data. In some embodiments, when a rejection of a new sales schedule is recorded, the server 102 selects another sales resource from the one or more sales resources for reassignment of the rejected sales schedule. The selection of the another sales resource is performed by the server 102 based at least on availability of the sales resources and previously generated sales leads matching output. The reassigned sales schedule is then issued by the server 102 to the selected sales resource for execution.

The acceptance or rejection information recorded by the server 102 is further stored as part of the execution data and is used in subsequent determination of key indicators and updating of sales leads and task matching operations, as described above. Further, the server 102 is configured to dynamically adjusts the new sales schedules based on detected execution events including at least one of cancellation, non-acceptance, or early completion. In dynamically adjusting the new sales schedules, the server 102 monitors execution data associated with execution of the issued new sales schedules to detect execution events that affect availability or timing of the one or more sales resources. When an execution event is detected, the server 102 modifies one or more aspects of the affected new sales schedules to reflect the detected execution event.

In some embodiments, when a cancellation or non-acceptance is detected, the server 102 removes or reschedules the affected assignment and generates an adjusted sales schedule for reassignment to another available sales resource from the one or more sales resources. When early completion of an assigned sales schedule is detected, the server 102 updates the availability of the corresponding sales resource and dynamically adjusts subsequent sales schedules to utilize the updated availability. The dynamically adjusted new sales schedules generated by the server 102 are stored and, when applicable, issued to available sales resources. The execution data associated with the dynamically adjusted new sales schedules is further recorded by the server 102 and used in subsequent determination of key indicators and updating of sales leads and task matching operations.

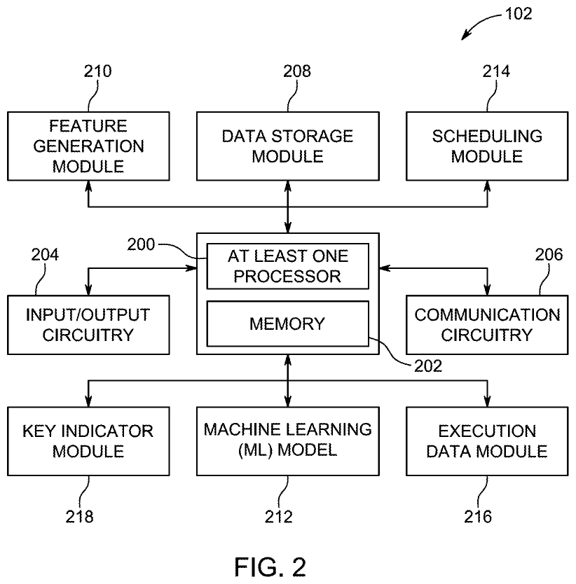

In some embodiments, the server 102 applies the hierarchy of criteria prior to generating the weighted feature values and prior to generating the sales leads matching output such that incompatible pairings are excluded from subsequent processing. By excluding incompatible pairings prior to generation of the sales leads matching output, the server 102 reduces processing associated with evaluating unsuitable pairings and improves efficiency of subsequent sales leads and task matching operations. Accordingly, FIG. 1 illustrates a high-level operational environment in which the server 102 centrally performs sales leads and task matching operations, including receipt of data, generation and issuance of sales schedules, recording of execution data, and dynamic adjustment of schedules based on execution events. The depiction of FIG. 1 is intended to illustrate functional interaction and data flow at a system level and is not intended to limit the internal structure or implementation of the server 102. The internal components, execution logic, and data processing mechanisms through which the server 102 performs the operations described above are described in further detail with reference to FIG. 2.

FIG. 2 illustrates a block diagram of the server 102, in accordance with an example embodiment of the present disclosure. In some embodiments, the server 102 comprises at least one processor 200, a memory 202, an input/output circuitry 204, a communication circuitry 206, a data storage module 208, a feature generation module 210, a machine learning (ML) module 212, a scheduling module 214, an execution module 216, a key indicator module 218.

In some embodiments, the data storage module 208 is configured to the store potential lead data, the one or more satellite images associated with the property of the one or more customers and the sales resources data associated with the one or more sales resources. In some embodiments, the data storage module 208 maintains the potential lead data in association with the one or more customers for use by the at least one processor 200 during sales leads and task matching operations. The potential lead data stored by the data storage module 208 includes information used to represent characteristics of the one or more customers relevant to assignment and scheduling decisions performed by the at least one processor 200. The data storage module 208 further stores the one or more satellite images associated with the property of the one or more customers. The stored one or more satellite images are accessible to the at least one processor 200 for determining one or more product parameters of the property, including at least a square footage area of the property or a material quantity associated with the property, as described above with reference to FIG. 1.

In addition, the data storage module 208 stores the sales resources data associated with the one or more sales resources available to receive sales schedules generated by the at least one processor 200. The sales resources data includes at least age information and education information of the one or more sales resources and is used by the at least one processor 200 for generating feature values, applying weighting factors, and generating sales leads matching output. In some embodiments, the data storage module 208 stores the potential lead data, the one or more satellite images, and the sales resources data in a manner that enables retrieval and association of such data during execution of sales leads and task matching operations. The data stored in the data storage module 208 is accessed by the at least one processor 200 for execution of instructions stored in the memory 202, as described in further detail below.

In some embodiments, the memory 202 is configured to store one or more instructions and The at least one processor 200 is communicatively coupled to the data storage module 208 and the memory 202. In some embodiments, the memory 202 is configured to store one or more instructions executable by the at least one processor 200 for performing sales leads and task matching operations described herein. The one or more instructions stored in the memory 202 correspond to logic for receiving data, generating feature values, applying weighting factors, generating sales leads matching output, generating sales schedules, recording execution data, determining key indicators, and updating sales leads and task matching operations. The at least one processor 200 is communicatively coupled to the data storage module 208 and the memory 202 and is configured to execute the one or more instructions stored in the memory 202. In executing the one or more instructions, the at least one processor 200 accesses the potential lead data, the one or more satellite images, the sales resources data, and other data stored in the data storage module 208 to perform the operations described with reference to FIG. 1.

In some embodiments, the at least one processor 200 coordinates operation of the feature generation module 210, the machine learning module 212, the scheduling module 214, the execution module 216, and the key indicator module 218 by executing the one or more instructions stored in the memory 202. The at least one processor 200 thereby controls data flow between the modules and performs processing required to generate sales leads matching output and new sales schedules. In some embodiments, the at least one processor 200 is configured to receive, via the data storage module 208, the potential lead data, the one or more satellite images and the sales resources data. In some embodiments, the sales resources data comprises at least age information and education information of the one or more sales resources.

In receiving the potential lead data, the one or more satellite images, and the sales resources data, the at least one processor 200 retrieves the corresponding data from the data storage module 208 for use in executing sales leads and task matching operations. The potential lead data retrieved by the at least one processor 200 is used to represent information associated with the one or more customers, and the sales resources data retrieved by the at least one processor 200 is used to represent attributes associated with the one or more sales resources available to receive sales schedules. The one or more satellite images retrieved by the at least one processor 200 are images associated with the property of the one or more customers and are used by the at least one processor 200 for determining one or more product parameters of the property. The at least one processor 200 accesses the potential lead data, the one or more satellite images, and the sales resources data in a coordinated manner such that the retrieved data can be processed together during subsequent feature generation, weighting, and matching operations. Further, the at least one processor 200 is configured to determine one or more product parameters of the property based at least on the received one or more satellite images. The one or more product parameters comprise at least one of the square footage area of the property or the material quantity associated with the property.

In determining the one or more product parameters, the at least one processor 200 analyses the received one or more satellite images associated with the property to identify dimensional characteristics of the property. Based at least on the analysis of the one or more satellite images, the at least one processor 200 derives measurement information corresponding to the property and calculates values representing the square footage area of the property. In some embodiments, the at least one processor 200 further determines the material quantity associated with the property based at least on the calculated square footage area of the property. The material quantity associated with the property represents an amount of material correlated to the square footage area of the property and is used by the at least one processor 200 as an input for subsequent sales leads and task matching operations. The processing of the satellite images comprises executing image-based computational routines by the at least one processor to determine the one or more product parameters without manual user input.

The determined one or more product parameters are stored in association with the potential lead data in the data storage module 208 and are subsequently retrieved by the at least one processor 200 for generating feature values and for performing further operations described below. In some embodiments, the at least one processor 200 retrieves the potential lead data, the one or more satellite images, and the sales resources data in response to execution of the one or more instructions stored in the memory 202. The retrieved data is temporarily maintained by the at least one processor 200 during execution of the instructions and is used as input for determining product parameters, generating feature values, and performing further sales leads and task matching operations, as described in subsequent sections.

Further, the at least one processor 200 is configured to generate, via the feature generation module 210, feature values derived from the potential lead data, the sales resources data, the one or more product parameters, and a previously saved sales schedules and execution data. In generating the feature values, the feature generation module 210 operates under control of the at least one processor 200 to transform the potential lead data, the sales resources data, the one or more product parameters, and the previously saved sales schedules and execution data into structured numerical representations usable for sales leads and task matching operations. The feature generation module 210 performs data processing operations that convert the received data into feature values that quantify attributes associated with the potential lead data, attributes associated with the sales resources data, and attributes associated with the one or more product parameters.

The feature generation module 210 accesses the potential lead data retrieved from the data storage module 208 to generate feature values representing characteristics associated with the one or more customers. The feature generation module 210 further accesses the sales resources data retrieved from the data storage module 208 to generate feature values representing attributes associated with the one or more sales resources. In addition, the feature generation module 210 uses the one or more product parameters determined by the at least one processor 200, including the square footage area of the property or the material quantity associated with the property, to generate corresponding feature values. The feature generation module 210 further incorporates historical information by accessing the previously saved sales schedules and the execution data stored in the data storage module 208. The previously saved sales schedules provide historical assignments of potential lead data to sales resources, and the execution data provides performance results associated with execution of the previously generated sales schedules. The feature generation module 210 generates feature values that reflect historical assignment patterns and performance outcomes derived from the execution data.

In some embodiments, the at least one processor 200 executes one or more instructions stored in the memory 202 to control operation of the feature generation module 210, including selection of input data, generation of feature values, and storage of the generated feature values in the data storage module 208. The generated feature values represent a transformed data set that is different in form from the input data and is structured for subsequent application of weighting factors and generation of sales leads matching output. By generating the feature values through the feature generation module 210, the server 102 performs a concrete data transformation that converts heterogeneous input data into structured numerical representations, thereby enabling automated sales leads and task matching operations and reducing reliance on manual data evaluation. In some embodiments, the feature values comprise numerical representations generated from at least one of attributes of the potential lead data, attributes of the sales resources data, and the one or more product parameters.

Further, the previously saved sales schedules comprise previously generated sales schedules stored in the data storage module and associated with historical assignments of the potential lead data to the one or more sales resources. In some embodiments, the execution data comprise data recorded by the system during execution of the previously generated sales schedules, including at least one of acceptance data, completion data, timing data, or sales outcome data.

Further, the at least one processor 200 is configured to apply, via the machine-learning model 212 communicatively coupled to the at least one processor 200, weighting factors to the generated feature values. In applying the weighting factors, the machine-learning module 212 operates under control of the at least one processor 200 to process the generated feature values produced by the feature generation module 210. The machine-learning module 212 applies stored weighting factors to the feature values to produce weighted feature values that reflect relative importance of different attributes associated with the potential lead data, the sales resources data, and the one or more product parameters. In some embodiments, the weighting factors applied by the machine-learning module 212 are stored in the memory 202 and are retrieved by the at least one processor 200 during execution of the one or more instructions. The at least one processor 200 supplies the generated feature values to the machine-learning module 212 and applies the weighting factors to the generated feature values in accordance with the instructions executed by the at least one processor 200.

The machine-learning module 212 applies the weighting factors such that feature values corresponding to attributes that have been determined to be more predictive of successful execution outcomes have a greater influence on subsequent sales leads and task matching operations. Conversely, feature values corresponding to attributes that have been determined to be less predictive have reduced influence. In some embodiments, the weighted feature values generated by the machine-learning module 212 are stored in the data storage module 208 and are subsequently retrieved by the at least one processor 200 for generation of sales leads matching output. The application of the weighting factors by the machine-learning module 212 produces a transformed data set that is different in form from the unweighted feature values and is specifically structured for automated compatibility evaluation between the potential lead data and the sales resources data. By applying the weighting factors through the machine-learning module 212, the server 102 enables adaptive and data-driven weighting of feature values, thereby improving accuracy and efficiency of subsequent sales leads matching operations performed by the at least one processor 200.

Further, the at least one processor 200 is configured to generate, via the machine-learning model 212 and based at least on the weighted feature values, the sales leads matching output for the pairing of one of the potential lead data and one of the sales resources data. In generating the sales leads matching output, the at least one processor 200 provides the weighted feature values to the machine-learning module 212 for evaluation. The machine-learning module 212 processes the weighted feature values to assess compatibility between the one of the potential lead data and the one of the sales resources data and produces the sales leads matching output corresponding to the evaluated pairing. In some embodiments, the sales leads matching output represents an output value or data structure generated by the machine-learning module 212 that identifies a suitability relationship between the one of the potential lead data and the one of the sales resources data based on the weighted feature values. The at least one processor 200 uses the sales leads matching output to distinguish between multiple possible pairings of the potential lead data and the sales resources data.

The machine-learning module 212 generates the sales leads matching output by applying learned weighting behaviour embodied in the applied weighting factors to the weighted feature values, thereby producing a consistent and repeatable evaluation of compatibility across different pairings. The sales leads matching output generated by the machine-learning module 212 is stored in the data storage module 208 and is subsequently retrieved by the at least one processor 200 for deriving a match percentage and for generating new sales schedules. By generating the sales leads matching output using weighted feature values processed by the machine-learning module 212, the server 102 performs a concrete computational operation that replaces manual lead-resource evaluation and improves efficiency and accuracy of automated sales leads and task matching operations.

Further, the at least one processor 200 is configured to derive, based at least on the generated sales leads matching output, the match percentage representing the predicted compatibility for the pairing between the one of the potential lead data and the one of the sales resources data. In deriving the match percentage, the at least one processor 200 processes the generated sales leads matching output to compute a numerical value representing predicted compatibility for the pairing between the one of the potential lead data and the one of the sales resources data. The match percentage quantifies the degree of compatibility determined by the machine-learning module 212 based on evaluation of the weighted feature values. In some embodiments, the at least one processor 200 derives the match percentage by normalizing or scaling the sales leads matching output into a percentage value that enables consistent comparison across different pairings of the potential lead data and the sales resources data. The derived match percentage provides a standardized measure that can be used by the at least one processor 200 for ranking pairings and for subsequent generation of new sales schedules.

The at least one processor 200 stores the derived match percentage in association with the corresponding pairing of the potential lead data and the sales resources data in the data storage module 208. The stored match percentage is subsequently retrieved by the at least one processor 200 for determining key indicators, updating weighting factors, and generating a next generation of new sales schedules, as described in further detail below. By deriving the match percentage from the sales leads matching output, the server 102 converts the compatibility evaluation into a concrete numerical representation that enables automated scheduling decisions and reduces reliance on subjective or manual compatibility assessment. Further, the machine-learning model comprises a plurality of executable instructions stored in the memory and configured to generate the match percentage using weighted feature values derived from the potential lead data, the sales resources data, and the execution data.

Further, the at least one processor 200 is configured to generate, via the scheduling module 214, new sales schedules based at least on the generated sales leads matching output and the derived match percentage, and issue the new sales schedules to available sales resources from the one or more sales resources. In generating the new sales schedules, the scheduling module 214 operates under control of the at least one processor 200 to select pairings of the potential lead data and the sales resources data based at least on the generated sales leads matching output and the derived match percentage. The scheduling module 214 identifies available sales resources from the one or more sales resources and assigns the potential lead data to the available sales resources in accordance with the derived match percentage.

In some embodiments, the scheduling module 214 generates the new sales schedules such that pairings associated with higher match percentages are prioritized over pairings associated with lower match percentages. The scheduling module 214 produces schedule data that defines assignment and timing information for execution by the available sales resources. The at least one processor 200 issues the new sales schedules generated by the scheduling module 214 to the available sales resources through the communication circuitry 206. The issued new sales schedules are stored in the data storage module 208 in association with the corresponding potential lead data and sales resources data for subsequent execution and monitoring. By generating and issuing the new sales schedules through the scheduling module 214, the server 102 automates assignment and scheduling operations that would otherwise require manual coordination, thereby improving efficiency and consistency of sales leads and task matching operations.

Further, the at least one processor 200 is configured to record, via the execution data module 216, execution data generated from execution of the new sales schedules, including sales outcomes associated with the issued sales schedules. In recording the execution data, the execution module 216 operates under control of the at least one processor 200 to collect information generated during execution of the issued new sales schedules by the available sales resources. The execution module 216 receives execution-related information associated with completion, acceptance, rejection, timing, and sales outcomes corresponding to the issued sales schedules. In some embodiments, the execution module 216 records the execution data in association with the corresponding new sales schedules, the potential lead data, and the sales resources data in the data storage module 208. The recorded execution data represents performance results of the issued sales schedules and provides objective feedback regarding actual outcomes of the scheduled assignments.

The at least one processor 200 accesses the execution data recorded by the execution module 216 for determining key indicators and for updating weighting factors applied during sales leads and task matching operations. By recording execution data through the execution module 216, the server 102 enables automated capture of outcome-based information that is used to improve subsequent sales leads and task matching operations without manual intervention. Further, the at least one processor 200 is configured to determine, via the 218 key indicator module, key indicators from the execution data. The key indicators include at least the match percentage, and a sales percentage representing an actual sales outcome. In determining the key indicators, the key indicator module 218 operates under control of the at least one processor 200 to analyze the execution data recorded by the execution module 216. The key indicator module 218 processes the execution data to extract performance-related values associated with execution of the new sales schedules.

In some embodiments, the key indicator module 218 associates the match percentage previously derived for a pairing of the one of the potential lead data and the one of the sales resources data with the corresponding execution data. The key indicator module 218 further determines the sales percentage representing the actual sales outcome based on the execution data recorded from execution of the issued sales schedules. The at least one processor 200 stores the determined key indicators in the data storage module 208 in association with the corresponding potential lead data, sales resources data, and new sales schedules. The stored key indicators are subsequently retrieved by the at least one processor 200 for updating weighting factors applied by the machine-learning module 212 and for generating a next generation of new sales schedules. By determining the key indicators through the key indicator module 218, the server 102 converts execution data into quantified performance measures that enable objective comparison between predicted compatibility and actual sales outcomes, thereby supporting automated improvement of sales leads and task matching operations.

Further, the at least one processor 200 is configured to update the machine-learning model 212 by adjusting weighting factors stored in the memory based at least on a comparison between the match percentage and the sales percentage. In updating the machine-learning model 212, the at least one processor 200 compares the match percentage representing predicted compatibility with the sales percentage representing the actual sales outcome for the same pairing of the potential lead data and the sales resources data. Based on the comparison, the at least one processor 200 determines whether the predicted compatibility corresponds to the actual sales outcome reflected in the execution data. In some embodiments, when the comparison indicates alignment between the match percentage and the sales percentage, the at least one processor 200 maintains the existing weighting factors stored in the memory. When the comparison indicates a divergence between the match percentage and the sales percentage, the at least one processor 200 adjusts one or more weighting factors stored in the memory to reduce the divergence for subsequent sales leads and task matching operations.

The adjusted weighting factors are applied by the machine-learning model 212 during subsequent application of weighting factors to generated feature values. By updating the weighting factors based on execution data, the at least one processor 200 enables the machine-learning model 212 to iteratively improve predicted compatibility accuracy over successive generations of sales schedules. In some embodiments, updating the machine-learning model 212 reduces processing associated with evaluation of incompatible pairings of potential lead data and sales resources data by increasing accuracy of weighting applied to feature values. This adaptive updating improves efficiency of the server 102 by reducing repeated processing of low-probability pairings and improving automated scheduling performance over time.

Further, the at least one processor 200 is configured to generate, via the scheduling module 214, a next generation of new sales schedules using the updated machine-learning model 212. In generating the next generation of new sales schedules, the scheduling module 214 operates under control of the at least one processor 200 to apply the updated weighting factors embodied in the updated machine-learning model 212. The at least one processor 200 provides the updated sales leads matching output generated using the updated machine-learning model 212 to the scheduling module 214 for use in generating revised schedule assignments. In some embodiments, the next generation of new sales schedules reflects modifications derived from execution data associated with prior sales schedules, including adjustments based on the comparison between predicted compatibility and actual sales outcomes. The scheduling module 214 prioritizes pairings of the potential lead data and the sales resources data using the updated weighting factors such that subsequent schedule assignments are improved relative to prior schedule generations.

The at least one processor 200 stores the next generation of new sales schedules in the data storage module 208 and issues the next generation of new sales schedules to available sales resources for execution. Execution data generated from execution of the next generation of new sales schedules is subsequently recorded by the execution module 216 and used by the at least one processor 200 for further updating of the machine-learning model 212, thereby enabling iterative improvement across successive schedule generations. By generating the next generation of new sales schedules using the updated machine-learning model 212, the server 102 performs adaptive scheduling operations that improve efficiency and effectiveness of sales leads and task matching operations over time. In some embodiments, updating the machine-learning model based on the execution data reduces a number of pairings of the potential lead data and the sales resources data processed by the at least one processor 200 when generating the next generation of new sales schedules.

In some embodiments, the machine-learning model 212 comprises a self-learning continuing improving set of algorithms configured to update the weighted feature values based on the execution data stored in the memory 202. In operating as a self-learning continuing improving set of algorithms, the machine-learning model 212 updates the weighted feature values by incorporating execution data stored in the memory 202 that reflects outcomes of previously generated sales schedules. The at least one processor 200 executes the one or more instructions stored in the memory 202 to cause the machine-learning model 212 to modify weighting factors applied to feature values based on performance results derived from the execution data. In some embodiments, the machine-learning model 212 evaluates differences between predicted compatibility represented by the match percentage and actual performance represented by the sales percentage included in the execution data. Based on such evaluation, the machine-learning model 212 adjusts the weighted feature values to increase influence of feature values associated with successful outcomes and to decrease influence of feature values associated with unsuccessful outcomes.

The updated weighted feature values produced by the self-learning continuing improving set of algorithms are stored in the memory 202 and are subsequently retrieved by the at least one processor 200 for generating sales leads matching output and new sales schedules in subsequent processing cycles. By continuously updating the weighted feature values based on execution data, the machine-learning model 212 enables iterative refinement of sales leads and task matching operations without manual reconfiguration. In some embodiments, operation of the self-learning continuing improving set of algorithms reduces repeated evaluation of incompatible pairings of the potential lead data and the sales resources data and improves processing efficiency of the server 102 over successive generations of new sales schedules. The self-learning continuing improving set of algorithms updates the weighted feature values further based on industry specific data and user input.

Further, the at least one processor 200 is configured to apply a hierarchy of criteria including mandatory criteria, disqualifying criteria, and weighted compatibility criteria to exclude incompatible pairings of potential lead data and sales resources data prior to generating the sales leads matching output. In applying the hierarchy of criteria, the at least one processor 200 evaluates the potential lead data and the sales resources data prior to generation of the sales leads matching output to identify pairings that are not eligible for further processing. The hierarchy of criteria is applied in a predefined order to progressively narrow candidate pairings of the potential lead data and the sales resources data. In some embodiments, the mandatory criteria represent conditions that must be satisfied for a pairing to remain eligible for further evaluation. Pairings that do not satisfy the mandatory criteria are excluded by the at least one processor 200 prior to application of additional criteria. The disqualifying criteria represent conditions that, when present, cause immediate exclusion of a pairing regardless of other attributes associated with the pairing.

After exclusion of pairings based on the mandatory criteria and the disqualifying criteria, the at least one processor 200 applies the weighted compatibility criteria to remaining eligible pairings. The weighted compatibility criteria are applied using the weighted feature values generated by the machine-learning model 212 to assess relative suitability of the remaining pairings. By excluding incompatible pairings prior to generation of the sales leads matching output, the at least one processor 200 reduces the number of pairings evaluated by the machine-learning model 212. This pre-processing operation improves processing efficiency of the server 102 and reduces computational resources required to generate the sales leads matching output and subsequent sales schedules.

Further, the at least one processor 200 is configured to determine location-based preferences, receive sales resources location data, and calculate drive times of the sales resources for adjusting the new sales schedules. In determining the location-based preferences, the at least one processor 200 evaluates geographic considerations associated with the potential lead data and the sales resources data to support efficient generation of the new sales schedules. The location-based preferences represent constraints or preferences related to geographic proximity between a property associated with the potential lead data and locations associated with the one or more sales resources. In some embodiments, the at least one processor 200 receives sales resources location data representing geographic locations of the one or more sales resources and calculates drive times of the sales resources to the property associated with the potential lead data. The calculated drive times are used by the at least one processor 200 to adjust the new sales schedules such that sales resources having shorter drive times to the property are prioritized over sales resources having longer drive times.

By way of a non-limiting real-life example, when multiple sales resources are available to service a potential lead associated with a property, the at least one processor 200 may determine that a first sales resource is located closer to the property than a second sales resource. Based on calculated drive times, the at least one processor 200 adjusts the new sales schedules to assign the potential lead data to the first sales resource, thereby reducing travel time and improving efficiency of schedule execution. In some embodiments, the at least one processor 200 adjusts the new sales schedules based on a combination of the derived match percentage and the calculated drive times such that a sales resource with a slightly lower match percentage but significantly shorter drive time may be selected over a sales resource with a higher match percentage but substantially longer drive time. This combined consideration enables balanced optimization of compatibility and logistical efficiency.

In some embodiments, the at least one processor 200 dynamically recalculates drive times based on updated sales resources location data and adjusts the new sales schedules in response to detected execution events, including cancellation, non-acceptance, or early completion. Such dynamic adjustment enables reassignment of sales schedules to alternative sales resources located closer to the property when execution conditions change. In some embodiments, the at least one processor 200 applies the location-based preferences as part of the hierarchy of criteria described above, such that geographic constraints are applied prior to or in combination with generation of the sales leads matching output. By incorporating location-based preferences and calculated drive times into scheduling decisions, the server 102 improves efficiency of sales schedule execution and reduces unnecessary travel associated with assignment of sales resources.

Further, the at least one processor 200 is configured to determine unavailable sales resources based on availability data stored in the memory 202, and to prevent issuance of the new sales schedules to the determined unavailable sales resources. In determining unavailable sales resources, the at least one processor 200 accesses availability data stored in the memory 202 that represents current availability status of the one or more sales resources. The availability data indicates whether a sales resource is able to receive and execute a new sales schedule at a given time. In some embodiments, the at least one processor 200 evaluates the availability data prior to issuance of the new sales schedules and identifies sales resources that are unavailable due to prior schedule assignments, execution events, or other availability constraints reflected in the availability data. Sales resources identified as unavailable are excluded by the at least one processor 200 from receiving the new sales schedules.

In preventing issuance of the new sales schedules to the determined unavailable sales resources, the at least one processor 200 ensures that the new sales schedules are issued only to available sales resources from the one or more sales resources. This prevention avoids conflicts in schedule execution and reduces the likelihood of reassignment caused by non-acceptance or cancellation. In some embodiments, the at least one processor 200 updates the availability data in the memory 202 based on execution data recorded from execution of previously issued sales schedules. The updated availability data is subsequently used by the at least one processor 200 during generation of the next generation of new sales schedules. By determining unavailable sales resources and preventing issuance of new sales schedules to such sales resources, the server 102 improves reliability of schedule execution, reduces reassignment operations, and enhances efficiency of sales leads and task matching operations.

Further, the at least one processor 200 is configured to record acceptance or rejection of the issued new sales schedules by the one or more sales resources and to reassign a rejected sales schedule to another sales resource selected from the one or more sales resources. In recording acceptance or rejection of the issued new sales schedules, the at least one processor 200 receives response information from the one or more sales resources indicating whether a corresponding new sales schedule has been accepted or rejected. The at least one processor 200 records the acceptance or rejection information in association with the issued new sales schedules, the potential lead data, and the sales resources data. In some embodiments, when a rejection of a new sales schedule is recorded, the at least one processor 200 identifies the rejected sales schedule as unexecuted and initiates a reassignment operation. During reassignment, the at least one processor 200 selects another sales resource from the one or more sales resources based at least on availability data stored in the memory 202 and previously generated sales leads matching output.

In some embodiments, the reassigned sales schedule is generated using the same sales leads matching output and derived match percentage or is regenerated using updated weighting factors when appropriate. The reassigned sales schedule is then issued by the at least one processor 200 to the selected sales resource for execution. The acceptance or rejection information recorded by the at least one processor 200 is further included as part of the execution data and is used in subsequent determination of key indicators and updating of the machine-learning model 212. By recording acceptance or rejection and performing reassignment operations, the server 102 improves reliability of schedule execution and reduces delays associated with unaccepted sales schedules.

In some embodiments, the at least one processor 200 is also configured to dynamically adjusts the new sales schedules based on detected execution events including at least one of cancellation, non-acceptance, or early completion. In dynamically adjusting the new sales schedules, the at least one processor 200 monitors the execution data recorded from execution of the issued new sales schedules to detect execution events that affect schedule fulfilment. The detected execution events include at least cancellation, non-acceptance, or early completion associated with execution of the new sales schedules. In some embodiments, when a cancellation or non-acceptance is detected, the at least one processor 200 identifies the affected sales schedule as unfulfilled and modifies the new sales schedules to remove or reschedule the affected assignment. The at least one processor 200 may reassign the affected sales schedule to another available sales resource from the one or more sales resources based on availability data and previously generated sales leads matching output.

In some embodiments, when early completion of a sales schedule is detected, the at least one processor 200 updates availability data stored in the memory 202 to reflect increased availability of the corresponding sales resource. Based on the updated availability data, the at least one processor 200 dynamically adjusts subsequent new sales schedules to utilize the updated availability. The dynamically adjusted new sales schedules generated by the at least one processor 200 are stored in the data storage module 208 and, when applicable, issued to available sales resources for execution. Execution data generated from execution of the dynamically adjusted new sales schedules is subsequently recorded and used for further determination of key indicators and updating of the machine-learning model 212. By dynamically adjusting the new sales schedules based on detected execution events, the server 102 improves responsiveness to real-time execution conditions, reduces idle time of sales resources, and enhances efficiency and reliability of sales leads and task matching operations.

In some embodiments, the at least one processor 200 is configured to generate differentiated subsets of the key indicators for presentation to different user roles including at least a business owner role, a manager role, and a sales resource role. In generating differentiated subsets of the key indicators, the at least one processor 200 selects and organizes portions of the key indicators based on relevance to different user roles associated with use of the server 102. The differentiated subsets are derived from the same execution data and key indicators but are tailored for presentation to different user roles. In some embodiments, for a business owner role, the at least one processor 200 generates a subset of the key indicators that emphasizes aggregated performance information derived from execution of the new sales schedules, including overall sales percentage and overall effectiveness of sales leads and task matching operations. This subset enables high-level evaluation of operational performance.

In some embodiments, for a manager role, the at least one processor 200 generates a subset of the key indicators that emphasizes performance information associated with groups of sales resources, including match percentage and sales percentage values associated with multiple sales schedules. This subset supports management of sales resources and evaluation of scheduling effectiveness. In some embodiments, for a sales resource role, the at least one processor 200 generates a subset of the key indicators that emphasizes performance information associated with execution of sales schedules by the corresponding sales resource, including match percentage and sales percentage associated with assigned potential lead data. This subset enables individual sales resources to evaluate execution outcomes. The differentiated subsets of the key indicators generated by the at least one processor 200 are provided for presentation through the user interface 104 and are updated based on newly recorded execution data. By generating differentiated subsets of the key indicators for different user roles, the server 102 improves usability of the system while maintaining a common underlying data set and consistent sales leads and task matching operations.

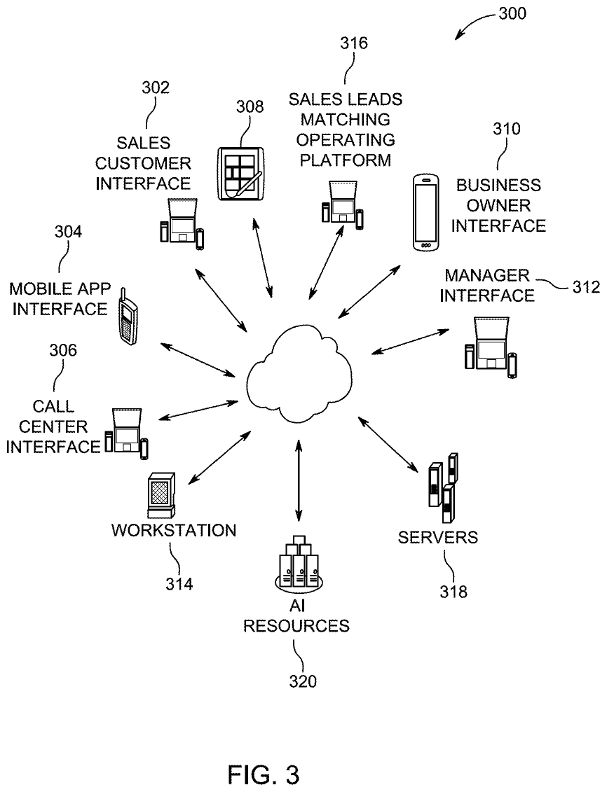

FIG. 3 illustrates an example operational environment 300 in which the sales leads and task matching system 100 is described herein may be implemented and used in a real-world scenario, in accordance with an example embodiment of the present disclosure.

In some embodiments, the operational environment 300 demonstrates interaction between a plurality of user interfaces, computing systems, and resources through a communications network, while core sales leads and task matching operations are performed by one or more servers, such as the server 102 described above. As shown in FIG. 3, a sales customer interface 302 may be used by one or more customers to provide information associated with potential lead data. In some embodiments, the sales customer interface 302 enables submission of information related to a property associated with the one or more customers, which may be used by the server 102 to receive the potential lead data and one or more satellite images associated with the property.

A mobile application interface 304 may be used by sales resources to receive issued new sales schedules, provide acceptance or rejection of the issued new sales schedules, and supply execution-related information during execution of the sales schedules. In some embodiments, the mobile application interface 304 enables sales resources to communicate availability information that is stored as availability data in the memory 202 and used by the server 102 to determine unavailable sales resources. A call center interface 306 may be used by call center personnel to input potential lead data received through customer interactions. The call center interface 306 communicates with the server 102 through the communications network 308 to transmit potential lead data and receive information associated with generated sales schedules.

A business owner interface 310 and a manager interface 312 may be used to access differentiated subsets of key indicators generated by the server 102. In some embodiments, the business owner interface 310 presents aggregated key indicators derived from execution data, while the manager interface 312 presents key indicators associated with performance of one or more sales resources. A workstation 314 may be used to access administrative or operational functionality of the sales leads matching operating platform 316. In some embodiments, the workstation 314 enables configuration of industry specific data and user input that are used by the server 102 to update weighted feature values and generate new sales schedules. The sales leads matching operating platform 316 represents the collective functionality provided by the server 102, including receiving potential lead data, determining one or more product parameters, generating feature values, applying weighting factors, generating sales leads matching output, issuing new sales schedules, recording execution data, determining key indicators, and updating the machine-learning model as described above.

One or more servers 318 operate in conjunction with the sales leads matching operating platform 316 to execute the processing functions described herein. The servers 318 communicate with user interfaces and computing devices through the communications network 308 to enable real-time or near real-time operation of the sales leads and task matching system. In some embodiments, AI resources 320 are accessed by the sales leads matching operating platform 316 to support execution of the machine-learning model used for generating the sales leads matching output and updating weighted feature values. The AI resources 320 operate under control of the at least one processor 200 and are used to improve accuracy and efficiency of sales leads and task matching operations.

In operation, potential lead data originating from one or more of the sales customer interface 302, the call center interface 306, or the workstation 314 is transmitted through the communications network 308 to the sales leads matching operating platform 316. The server 102 processes the potential lead data together with sales resources data and execution data to generate new sales schedules that are issued to sales resources through the mobile application interface 304. Execution data generated from execution of the new sales schedules is transmitted back to the sales leads matching operating platform 316 through the communications network 308 and is recorded by the server 102. The recorded execution data is used to determine key indicators and update weighting factors for subsequent generations of new sales schedules.

By operating within the environment 300 illustrated in FIG. 3, the sales leads and task matching system 100 enables coordinated interaction between multiple user roles and computing systems while maintaining centralized automated processing at the server 102. This configuration allows the system to dynamically adapt sales schedules, improve matching accuracy, and enhance processing efficiency over successive executions.

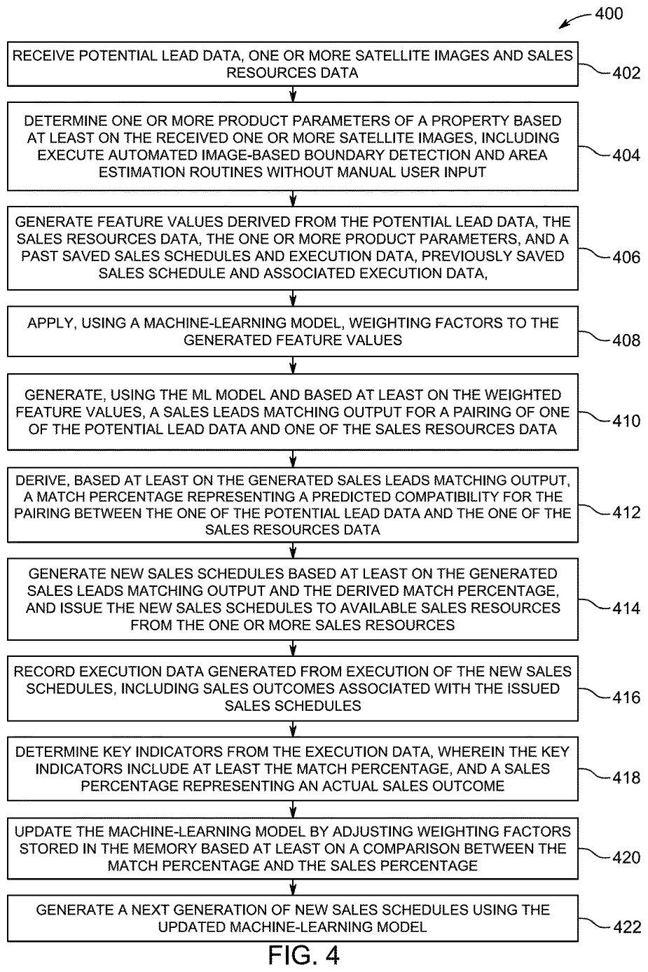

FIG. 4 illustrates a flowchart 400 for showing a method for sales leads and task matching, in accordance with an example embodiment of the present disclosure.

At operation 402, the at least one processor 200 is configured to receive, via the data storage module 208, the potential lead data, the one or more satellite images and the sales resources data. At this operation, the at least one processor 200 initiates a processing cycle for sales leads and task matching by accessing data required for subsequent operations. The at least one processor 200 retrieves the potential lead data, the one or more satellite images, and the sales resources data from the data storage module 208. This operation establishes a unified data set that is used throughout the remaining operations of the flowchart. In some embodiments, the potential lead data includes information associated with one or more customers and a property corresponding to the one or more customers. The one or more satellite images are associated with the property and provide image-based information used for determining product-related characteristics of the property. The sales resources data includes information associated with the one or more sales resources, including at least age information and education information of the one or more sales resources. By receiving the potential lead data, the one or more satellite images, and the sales resources data at the start of the flow, the at least one processor 200 ensures that subsequent operations are performed using current and consistent data stored in the data storage module 208.

In one example, a potential customer named John Smith submits a request for a sales consultation related to a residential property located at 123 Oak Street. Information associated with this request is stored as potential lead data in the data storage module 208. The potential lead data includes customer contact information and an identifier associated with the property. The data storage module 208 also stores one or more satellite images corresponding to the property at 123 Oak Street, which were previously retrieved from an image source and associated with the property. At the same time, the data storage module 208 stores sales resources data associated with multiple sales resources, such as Sales Resource A (age 35, college education) and Sales Resource B (age 52, technical education). Each sales resource has corresponding sales resources data stored in the data storage module 208. The at least one processor 200 retrieves the potential lead data associated with John Smith, the one or more satellite images of the property at 123 Oak Street, and the sales resources data associated with Sales Resource A and Sales Resource B. This retrieved data forms the input set that is used in subsequent operations of FIG. 4 to determine product parameters, generate feature values, and perform sales leads and task matching.

At operation 404, the at least one processor 200 is configured to determine one or more product parameters of the property based at least on the received one or more satellite images, including executing automated image-based boundary detection and area estimation routines without manual user input. In some embodiments, the at least one processor 200 processes the one or more satellite images associated with the property to extract information usable for sales leads and task matching. In some embodiments, determining the one or more product parameters comprises executing image-based computational routines including automated boundary detection and area estimation without manual user input. The at least one processor 200 analyses the received one or more satellite images to determine one or more product parameters of the property without requiring manual user input. In some embodiments, determining the one or more product parameters includes computing a square footage area of the property based on visual characteristics identified in the one or more satellite images. In some embodiments, determining the one or more product parameters includes estimating a material quantity associated with the property based on the square footage area or other image-based characteristics observable in the one or more satellite images. The determined one or more product parameters are associated with the potential lead data and stored for use in subsequent operations of the flowchart, including generation of feature values and sales leads matching output. By deriving the one or more product parameters directly from the one or more satellite images, the at least one processor 200 enables automated and consistent determination of property-related characteristics.

In one example, the at least one processor 200 analyzes the one or more satellite images associated with the property located at 123 Oak Street. Based on the visual footprint of the structure shown in the satellite images, the at least one processor 200 determines that the property has an estimated square footage area of approximately 2,400 square feet. Using the determined square footage area, the at least one processor 200 further determines a material quantity associated with the property. For example, when the potential lead data is associated with a sales consultation for exterior materials, the at least one processor 200 estimates that approximately 2,400 square feet of material may be required for the property. The determined square footage area and material quantity are recorded as the one or more product parameters associated with the potential lead data for John Smith. These product parameters are then used in subsequent operations of FIG. 4 to generate feature values and perform sales leads and task matching.

At operation 406, the at least one processor 200 is configured to generate, via feature generation module, feature values derived from the potential lead data, the sales resources data, the one or more product parameters, and a previously saved sales schedules and associated execution data. In some embodiments, the at least one processor 200 consolidates multiple categories of data into a structured form suitable for automated analysis. The at least one processor 200 invokes the feature generation module to generate feature values from the potential lead data, the sales resources data, the one or more product parameters, and the previously saved sales schedules and execution data.

In some embodiments, the feature generation module converts attributes contained within the potential lead data, the sales resources data, and the one or more product parameters into numerical representations. These numerical representations collectively form the feature values that characterize both the potential lead data and the sales resources data in a format usable for subsequent weighting and matching operations. The previously saved sales schedules and execution data are used by the feature generation module to generate feature values that reflect historical performance and prior scheduling outcomes. By incorporating previously saved sales schedules and execution data, the at least one processor 200 ensures that the generated feature values reflect both current conditions and historical execution results. The generated feature values are stored in association with the potential lead data and the sales resources data and are provided for use in subsequent operations of the flowchart, including application of weighting factors and generation of sales leads matching output.

In one example, the example involving John Smith and the property at 123 Oak Street, the at least one processor 200 generates feature values using the feature generation module based on multiple data sources. From the potential lead data, the feature generation module generates feature values representing attributes such as the type of requested sales consultation and the location of the property. From the one or more product parameters determined earlier, the feature generation module generates numerical feature values representing the square footage area of 2,400 square feet and the estimated material quantity associated with the property. From the sales resources data, the feature generation module generates feature values for Sales Resource A (age 35, college education) and Sales Resource B (age 52, technical education). From the previously saved sales schedules and execution data, the feature generation module generates feature values representing historical outcomes, such as prior sales percentages achieved by each sales resource on similar properties. As a result, the at least one processor 200 generates a set of feature values that collectively represent the potential lead data associated with John Smith, the characteristics of the property at 123 Oak Street, and historical performance of the available sales resources. These feature values are then passed to the next operation in FIG. 4 for application of weighting factors and generation of sales leads matching output.

At operation 408, the at least one processor 200 is configured to apply, via the machine-learning model 212 communicatively coupled to the at least one processor, weighting factors to the generated feature values. In some embodiments, the at least one processor 200 applies weighting factors to the generated feature values to control relative influence of different attributes during sales leads and task matching. The weighting factors are applied through execution of the machine-learning model 212 communicatively coupled to the at least one processor 200. In some embodiments, the machine-learning model 212 assigns different weighting factors to different feature values based on their relevance to successful execution of prior sales schedules. Feature values derived from execution data and previously saved sales schedules may be assigned higher weighting factors when historical performance indicates a stronger correlation with positive sales outcomes. Feature values derived from other attributes may be assigned lower weighting factors when historical execution data indicates reduced influence.

The application of weighting factors produces weighted feature values that reflect relative importance of attributes associated with the potential lead data, the sales resources data, and the one or more product parameters. The weighted feature values are stored in association with the potential lead data and the sales resources data and are provided for use in subsequent operations of the flowchart, including generation of the sales leads matching output. By applying weighting factors through the machine-learning model 212, the at least one processor 200 enables adaptive and data-driven prioritization of attributes without manual adjustment, thereby improving consistency and efficiency of sales leads and task matching operations.

In one example, John Smith and the property at 123 Oak Street, the at least one processor 200 applies weighting factors to the feature values generated in operation 406. For example, the machine-learning model 212 applies a higher weighting factor to the feature value representing historical sales percentage achieved by Sales Resource A on properties with similar square footage. The model applies a moderate weighting factor to the feature value representing age information of the sales resources and a lower weighting factor to the feature value representing education information when historical execution data indicates that education has less influence on sales outcomes for similar properties. The feature value representing the square footage area of 2,400 square feet is assigned a weighting factor based on prior execution data indicating that properties of similar size benefit from assignment to sales resources with prior experience on comparable properties. As a result, the at least one processor 200 produces weighted feature values that emphasize attributes most relevant to successful execution of sales schedules for the potential lead data associated with John Smith. These weighted feature values are then used in the next operation of FIG. 4 to generate a sales leads matching output.

At operation 410, the at least one processor 200 is configured to generate, via the machine-learning model 212 and based at least on the weighted feature values, the sales leads matching output for a pairing of one of the potential lead data and one of the sales resources data. In some embodiments, the at least one processor 200 evaluates compatibility between the potential lead data and the sales resources data using the weighted feature values generated in the previous operation. The at least one processor 200 supplies the weighted feature values to the machine-learning model 212, which processes the weighted feature values to generate the sales leads matching output for a pairing of one of the potential lead data and one of the sales resources data.

In some embodiments, the sales leads matching output represents a compatibility assessment produced by the machine-learning model 212 that reflects how well a particular sales resource aligns with the potential lead data based on the weighted feature values. The at least one processor 200 may generate the sales leads matching output for multiple pairings of the potential lead data and the sales resources data and use the generated outputs to distinguish among the available sales resources. The generated sales leads matching output is stored in association with the evaluated pairing and is used in subsequent operations of the flowchart to derive a match percentage and generate new sales schedules. By generating the sales leads matching output based on weighted feature values, the at least one processor 200 replaces manual evaluation of sales resource suitability with a repeatable, data-driven compatibility determination.

In one example, Continuing the example involving John Smith and the property at 123 Oak Street, the at least one processor 200 evaluates compatibility between the potential lead data associated with John Smith and the sales resources data associated with Sales Resource A and Sales Resource B. Using the weighted feature values generated in operation 408, the machine-learning model 212 processes the feature values for each pairing. For example, the pairing between John Smith and Sales Resource A produces a higher sales leads matching output because the weighted feature values reflect strong historical performance of Sales Resource A on properties with similar square footage and material requirements. The pairing between John Smith and Sales Resource B produces a lower sales leads matching output due to weaker historical outcomes reflected in the execution data. The at least one processor 200 stores the sales leads matching output for each pairing and identifies the pairing with Sales Resource A as more compatible based on the generated sales leads matching output. These stored outputs are then used in the next operation of FIG. 4 to derive match percentages representing predicted compatibility.

At operation 412, the at least one processor 200 is configured to derive, based at least on the generated sales leads matching output, the match percentage representing a predicted compatibility for the pairing between the one of the potential lead data and the one of the sales resources data. In some embodiments, the at least one processor 200 converts the sales leads matching output generated in the prior operation into a quantitative measure that can be directly used for scheduling decisions. The at least one processor 200 processes the generated sales leads matching output to derive a match percentage representing predicted compatibility for the pairing between the one of the potential lead data and the one of the sales resources data. In some embodiments, deriving the match percentage includes scaling, normalizing, or otherwise transforming the sales leads matching output into a percentage value that allows comparison across multiple pairings. The match percentage provides a standardized representation of predicted compatibility that can be ranked or thresholded by the at least one processor 200. The derived match percentage is stored in association with the corresponding pairing of the potential lead data and the sales resources data and is used in subsequent operations of the flowchart to generate new sales schedules and to determine key indicators based on execution outcomes. By expressing compatibility as a match percentage, the at least one processor 200 enables consistent, automated decision-making without reliance on subjective evaluation.

In one example, John Smith and the property at 123 Oak Street, the at least one processor 200 processes the sales leads matching output generated in operation 410. For the pairing between John Smith and Sales Resource A, the sales leads matching output generated by the machine-learning model 212 is converted into a match percentage of approximately 82%, indicating a high predicted compatibility. For the pairing between John Smith and Sales Resource B, the corresponding sales leads matching output is converted into a match percentage of approximately 55%, indicating lower predicted compatibility. The at least one processor 200 stores these match percentages in association with the respective pairings and identifies the pairing with Sales Resource A as the more compatible option based on the higher match percentage. These derived match percentages are then used in the next operation of FIG. 4 to generate new sales schedules that prioritize higher-compatibility pairings.

At operation 414, the at least one processor 200 is configured to generate, via the scheduling module 214, new sales schedules based at least on the generated sales leads matching output and the derived match percentage, and issue the new sales schedules to available sales resources from the one or more sales resources.

In one example, John Smith and the property at 123 Oak Street, the at least one processor 200 uses the derived match percentages to generate new sales schedules through the scheduling module 214. Based on the match percentages derived in operation 412, the pairing between John Smith and Sales Resource A has a match percentage of approximately 82%, which is higher than the match percentage associated with Sales Resource B. The scheduling module 214 prioritizes the pairing with Sales Resource A when generating the new sales schedules. Before issuing the new sales schedules, the at least one processor 200 confirms that Sales Resource A is available based on availability data stored in the memory 202. Upon confirming availability, the scheduling module 214 generates a new sales schedule assigning Sales Resource A to conduct a sales appointment for John Smith at 123 Oak Street on a selected date and time, such as March 15 at 10:00 a.m.

The at least one processor 200 then issues the generated new sales schedule to Sales Resource A through a user interface, such as a mobile application interface. The issued new sales schedule includes information associated with the potential lead data, the property, and the scheduled appointment, enabling Sales Resource A to prepare for and execute the sales appointment. If multiple potential lead data entries are being processed, the scheduling module 214 generates corresponding new sales schedules for each pairing based on the respective sales leads matching outputs and derived match percentages, ensuring that available sales resources are assigned to the most compatible potential leads.

At operation 416, the at least one processor 200 is configured to record, via the execution data module 216, execution data generated from execution of the new sales schedules, including sales outcomes associated with the issued sales schedules.

In one example, Sales Resource A is assigned to the sales appointment with John Smith at 123 Oak Street, the at least one processor 200 records execution data generated during and after execution of the issued new sales schedule using the execution data module 216. For example, Sales Resource A attends the scheduled appointment on March 15 at 10:00 a.m. and completes the sales consultation. During execution of the new sales schedule, the execution data module 216 records execution data including whether the appointment was attended as scheduled, the duration of the appointment, and whether the sales appointment resulted in a completed sale.

In this example, the sales appointment results in a completed sale with a total sale value of $18,000. The execution data module 216 records this sales outcome in association with the issued new sales schedule, along with timing information indicating that the appointment was completed without cancellation or delay. The recorded execution data is stored in the data storage module 208 and associated with the corresponding potential lead data and sales resources data. This execution data is then available for use in subsequent operations of FIG. 4, including determination of key indicators and updating of weighting factors used in future generations of new sales schedules.

At operation 418, the at least one processor 200 is configured to determine, via key indicator module, key indicators from the execution data, wherein the key indicators include at least the match percentage, and a sales percentage representing an actual sales outcome.

In one example, execution of the sales appointment between Sales Resource A and John Smith, the at least one processor 200 processes the recorded execution data using the key indicator module to determine key indicators associated with the executed sales schedule. In this example, the match percentage previously derived for the pairing between John Smith and Sales Resource A was approximately 82%. The execution data recorded in operation 416 indicates that the sales appointment resulted in a completed sale. Based on the recorded sales outcome, the key indicator module determines a sales percentage representing the actual sales outcome for the pairing. For example, if Sales Resource A successfully converts 82 out of 100 similar appointments into completed sales over a defined period, the sales percentage determined for this execution may be approximately 82%. The key indicator module associates the match percentage and the sales percentage with the executed sales schedule and stores the key indicators in the data storage module 208. These key indicators enable comparison between predicted compatibility and actual sales performance.

At operation 420, the at least one processor 200 is configured to update the machine-learning model by adjusting weighting factors stored in the memory based at least on a comparison between the match percentage and the sales percentage, the updation reduces computational processing in subsequent matching operations.

In one example, John Smith and Sales Resource A, the at least one processor 200 compares the match percentage derived earlier with the sales percentage determined from the execution data. In this example, the match percentage for the pairing between John Smith and Sales Resource A was approximately 82%, indicating a high predicted compatibility. The sales percentage determined from the execution data also reflects a successful outcome, such as a completed sale resulting from the issued new sales schedule. Because the predicted compatibility closely aligns with the actual sales outcome, the at least one processor 200 determines that the weighting factors applied to the feature values for this pairing were effective. Based on this comparison, the at least one processor 200 updates the machine-learning model by reinforcing the weighting factors stored in the memory that contributed to the accurate prediction. In contrast, if the sales percentage had been significantly lower than the match percentage, the at least one processor 200 would adjust the weighting factors to reduce the influence of feature values that led to the inaccurate prediction.

The updated weighting factors are stored in the memory and incorporated into the machine-learning model for use in subsequent processing cycles. As a result, future sales leads matching outputs and derived match percentages are generated using weighting factors that reflect actual execution outcomes, enabling the system to progressively improve accuracy and effectiveness of sales leads and task matching operations over time.

At operation 422, the at least one processor 200 is configured to generate, via the scheduling module, a next generation of new sales schedules using the updated machine-learning model.

In one example, after the machine-learning model has been updated in operation 420, the at least one processor 200 generates a next generation of new sales schedules using the updated weighting factors through the scheduling module. In this example, a new potential lead is received for a different property with characteristics similar to the property at 123 Oak Street. When the at least one processor 200 processes this new potential lead data, the updated machine-learning model applies the adjusted weighting factors that were refined based on the successful outcome of the prior sales schedule involving Sales Resource A.

As a result, the scheduling module generates a next generation of new sales schedules that more strongly prioritize sales resources with demonstrated success on similar properties. For instance, Sales Resource A may again receive a higher match percentage for similar potential lead data, while sales resources with lower historical performance receive lower match percentages. The at least one processor 200 issues the next generation of new sales schedules to available sales resources using these updated predictions, thereby improving scheduling accuracy and reducing assignment of potential leads to less compatible sales resources. This iterative scheduling process enables the system to continuously refine sales schedules based on real execution outcomes, resulting in improved efficiency and effectiveness over successive generations of new sales schedules.

In some embodiments, the sales leads and task matching system 100 further provides a technical advantage by enabling selective exclusion of incompatible pairings prior to execution of the machine-learning model 212 through application of mandatory criteria, disqualifying criteria, and weighted compatibility criteria. By eliminating incompatible pairings before generation of sales leads matching output, the at least one processor reduces the number of feature combinations processed by the machine-learning model, thereby decreasing computational load and improving response time. This pre-filtering mechanism, combined with iterative updating of weighting factors based on execution data, enables the system to converge toward higher-quality scheduling decisions with fewer processing cycles, which is particularly advantageous in environments involving large volumes of potential lead data and sales resources data.

In some embodiments, the sales leads and task matching system 100 described herein provides a technical improvement to computer-based scheduling and matching systems by replacing manual, static, and rule-bound lead assignment processes with an adaptive, execution-driven computational framework. By automatically generating feature values from heterogeneous data sources including potential lead data, sales resources data, one or more product parameters derived from satellite images, and historical execution data the system enables structured, machine-readable representations that are continuously refined through machine-learning-based weighting adjustments. The iterative comparison between predicted compatibility, represented by the match percentage, and actual execution outcomes, represented by the sales percentage, allows the system to dynamically update internal weighting factors stored in memory, thereby improving predictive accuracy over successive scheduling cycles. This architecture reduces unnecessary computational reprocessing of incompatible lead resource pairings, improves scheduling efficiency, and enhances utilization of processing resources relative to conventional systems that repeatedly evaluate the same combinations without learning from execution outcomes. As a result, the system improves both operational efficiency and computational performance while providing consistent, scalable, and data-driven sales leads matching across varying operating conditions.

Many modifications and other embodiments of the disclosure set forth herein will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A sales leads and task matching system, comprising:
a data storage module configured to store potential lead data, one or more satellite images associated with a property of one or more customers, and sales resources data associated with one or more sales resources;
a memory configured to store one or more instructions; and
at least one processor communicatively coupled to the data storage module and the memory;
a feature generation module communicatively coupled to the at least one processor;
a scheduling module communicatively coupled to the at least one processor;
an execution data module communicatively coupled to the at least one processor; and
a key indicator module communicatively coupled to the at least one processor;
wherein the at least one processor, when executing the one or more instructions, is configured to:
receive, via the data storage module, the potential lead data, the one or more satellite images, and the sales resources data, wherein the sales resources data comprises at least age information and education information of the one or more sales resources;
determine one or more product parameters of the property based at least on the received one or more satellite images, wherein determining the one or more product parameters comprises executing image-based computational routines including automated boundary detection and area estimation without manual user input, wherein the one or more product parameters comprise at least one of a square footage area of the property or a material quantity associated with the property;
generate, via the feature generation module, feature values derived from the potential lead data, the sales resources data, the one or more product parameters, and previously saved sales schedules and associated execution data;
apply, via a machine-learning model communicatively coupled to the at least one processor, weighting factors to the generated feature values;
generate, via the machine-learning model and based at least on the weighted feature values, a sales leads matching output for a pairing of one of the potential lead data and one of the sales resources data;
derive, based at least on the generated sales leads matching output, a match percentage representing a predicted compatibility for the pairing between the one of the potential lead data and the one of the sales resources data;
generate, via the scheduling module, new sales schedules based at least on the generated sales leads matching output and the derived match percentage, and issue the new sales schedules to available sales resources;
record, via the execution data module, execution data generated from execution of the new sales schedules, including sales outcomes associated with the issued sales schedules;
determine, via the key indicator module, key indicators from the execution data, wherein the key indicators include at least the match percentage, and a sales percentage representing an actual sales outcome; and
update the machine-learning model by adjusting weighting factors stored in the memory based at least on a comparison between the match percentage and the sales percentage, to generate, via the scheduling module, a next generation of new sales schedules, wherein updating the machine-learning model reduces computational processing of incompatible pairings and improves efficiency and accuracy of subsequent schedule generation cycles.

2. The sales leads and task matching system of claim 1, wherein the feature values comprise numerical representations generated from at least one of attributes of the potential lead data, attributes of the sales resources data, and the one or more product parameters.

3. The sales leads and task matching system of claim 1, wherein the previously saved sales schedules comprise previously generated sales schedules stored in the data storage module and associated with historical assignments of the potential lead data to the one or more sales resources.

4. The sales leads and task matching system of claim 3, wherein the execution data comprise data recorded by the system during execution of the previously generated sales schedules, including at least one of acceptance data, completion data, timing data, or sales outcome data.

5. The sales leads and task matching system of claim 1, wherein the machine-learning model comprises a plurality of executable instructions stored in the memory and configured to generate the match percentage using weighted feature values derived from the potential lead data, the sales resources data, and the execution data.

6. The sales leads and task matching system of claim 5, wherein the machine-learning model comprises a self-learning continuing improving set of algorithms configured to update the weighted feature values based on the execution data stored in the memory.

7. The sales leads and task matching system of claim 6, wherein the self-learning continuing improving set of algorithms updates the weighted feature values further based on industry specific data and user input.

8. The sales leads and task matching system of claim 1, wherein the at least one processor, when executing the one or more instructions, is further configured to apply a hierarchy of criteria including mandatory criteria, disqualifying criteria, and weighted compatibility criteria to exclude incompatible pairings of potential lead data and sales resources data prior to generating the sales leads matching output.

9. The sales leads and task matching system of claim 1, wherein the at least one processor when executing the one or more instructions, is further configured to determine location-based preferences, receive sales resources location data, and calculate drive times of the sales resources for adjusting the new sales schedules.

10. The sales leads and task matching system of claim 1, wherein the at least one processor when executing the one or more instructions, is further configured to determine unavailable sales resources based on availability data stored in the memory, and to prevent issuance of the new sales schedules to the determined unavailable sales resources.

11. The sales leads and task matching system of claim 1, wherein processing the satellite images comprises executing image-based computational routines by the at least one processor to determine the one or more product parameters without manual user input.

12. The sales leads and task matching system of claim 1, wherein updating the machine-learning model based on the execution data reduces a number of pairings of the potential lead data and the sales resources data processed by the at least one processor when generating the next generation of new sales schedules.

13. The sales leads and task matching system of claim 1, wherein updating the machine-learning model comprises training the machine-learning model using execution data stored in the memory within a rolling temporal window.

14. The sales leads and task matching system of claim 1, wherein the at least one processor, when executing the one or more instructions, is further configured to record acceptance or rejection of the issued new sales schedules by the one or more sales resources and to reassign a rejected sales schedule to another sales resource selected from the one or more sales resources.

15. The sales leads and task matching system of claim 1, wherein the at least one processor, when executing the one or more instructions, dynamically adjusts the new sales schedules based on detected execution events including at least one of cancellation, non-acceptance, or early completion.

16. The sales leads and task matching system of claim 1, wherein the at least one processor generates differentiated subsets of the key indicators for presentation to different user roles including at least a business owner role, a manager role, and a sales resource role.

17. A computer-implemented method for sales lead matching and task scheduling, executed by at least one processor communicatively coupled to a data storage module and a memory, the method comprising:
receiving potential lead data, one or more satellite images, and sales resources data;
determining one or more product parameters of the property based at least on the received one or more satellite images, including executing automated image-based boundary detection and area estimation routines without manual user input;
generating feature values derived from the potential lead data, the sales resources data, the one or more product parameters, and a previously saved sales schedules and associated execution data;
applying, using a machine-learning model, weighting factors to the generated feature values;
generating, using the machine-learning model, a sales lead matching output for a pairing of one of the potential lead data and one of the sales resources data;
deriving a match percentage representing predicted compatibility for the pairing between the one of the potential lead data and the one of the sales resources data, based at least on the generated sales leads matching output;
generating, using a scheduling module, new sales schedules based at least on the generated sales leads matching output and the derived match percentage, and issue the new sales schedules to available sales resources from the one or more sales resources;
recording, using an execution data module, execution data generated from execution of the new sales schedules, including sales outcomes associated with the issued sales schedules;
determining, using a key indicator module, key indicators from the execution data, wherein the key indicators include at least the match percentage, and a sales percentage representing an actual sales outcome; and
updating the machine-learning model by adjusting weighting factors stored in the memory based at least on a comparison between the match percentage and the sales percentage to generate, a next generation of new sales schedules, wherein the updating reduces computational processing in subsequent matching operations.

18. The method of claim 17 further comprising applying, via the at least one processor, a hierarchy of criteria including mandatory criteria, disqualifying criteria, and weighted compatibility criteria to exclude incompatible pairings of potential lead data and sales resources data prior to generating the sales leads matching output.

19. The method of claim 17 further comprising determining, via the at least one processor, location-based preferences, receiving sales resources location data, and calculating drive times of the sales resources for adjusting the new sales schedules.

20. A non-transitory computer-readable medium storing instructions that, when executed by at least one processor, cause the at least one processor to:
receiving, via at least one processor communicatively coupled to a data storage module and a memory, a potential lead data, one or more satellite images and sales resources data from the data storage module, wherein the sales resources data comprises at least age information and education information of the one or more sales resources;
determining, via the at least one processor, one or more product parameters of the property based at least on the received one or more satellite images, wherein the one or more product parameters comprise at least one of a square footage area of the property or a material quantity associated with the property;
generating, via the at least one processor, feature values derived from the potential lead data, the sales resources data, the one or more product parameters, and a previously saved sales schedules and associated execution data;
applying, via the at least one processor and using a machine-learning model communicatively coupled to the at least one processor, weighting factors to the generated feature values;
generating, via the at least one processor and using the machine-learning model, a sales leads matching output for a pairing of one of the potential lead data and one of the sales resources data, based at least on the weighted feature values;
deriving, via the at least one processor, a match percentage representing a predicted compatibility for the pairing between the one of the potential lead data and the one of the sales resources data, based at least on the generated sales leads matching output;
generating, via the at least one processor using a scheduling module, new sales schedules based at least on the generated sales leads matching output and the derived match percentage, and issue the new sales schedules to available sales resources from the one or more sales resources;
recording, via the at least one processor using an execution data module, execution data generated from execution of the new sales schedules, including sales outcomes associated with the issued sales schedules;
determining, via the at least one processor using a key indicator module, key indicators from the execution data, wherein the key indicators include at least the match percentage, and a sales percentage representing an actual sales outcome; and
updating, via the at least one processor, the machine-learning model by adjusting weighting factors stored in the memory based at least on a comparison between the match percentage and the sales percentage, to generate a next generation of new sales schedules.
